(19) United States
(12) Patent Application Publication
(10) Pub. No.: US 2007/0261420 A1
(43) Pub. Date: Nov. 15, 2007

(54) Method and Device for Controlling a Coolant Circuit of an Air Conditioning System for a Vehicle

(75) Inventors: Wilhelm Baruschke, Wangen (DE); Armin Britsch-Laudwein, Renningen (DE); Karl Lochmahr, Vaihingen/Enz (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 11/629,706

(22) PCT Filed: Jun. 1, 2005
(86) PCT No.: PCT/EP05/05878

§ 371 Date: Jun. 26, 2007

(30) Foreign Application Priority Data
Jun. 17, 2004 (DE) 10 2004 029 166.7

(51) Int. Cl. B60H 1/32

(52) U.S. Cl. 62/115; 62/230

(57) ABSTRACT

The invention relates to a method for controlling a coolant circuit (2) of an air conditioning system (4) for a vehicle. According to said method, a compressor (10) that is located in the coolant circuit (2) is controlled in accordance with an evaporator temperature controller (VR) and a load torque limitation function (22) that is integrated into said evaporator temperature controller (VR).

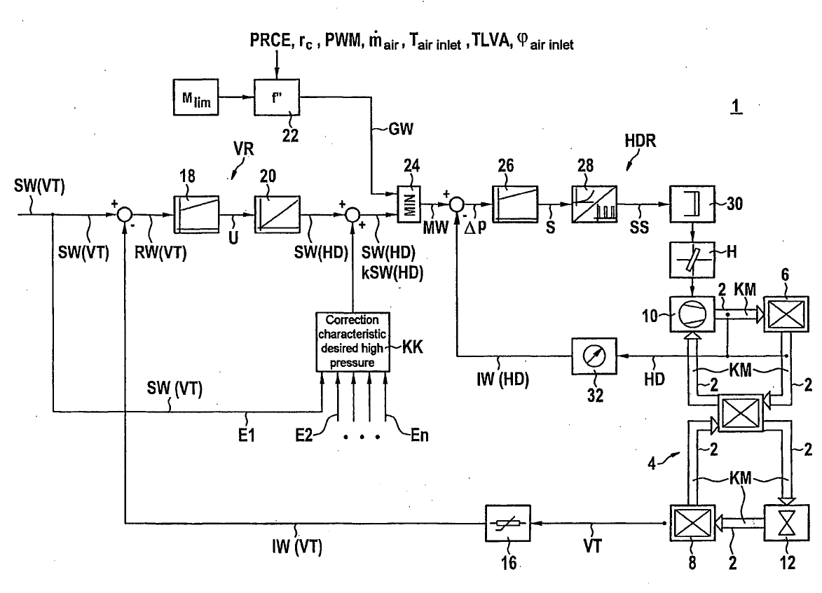

The invention relates to a method and an apparatus for controlling a refrigerant circuit, for example an R744 refrigerant circuit (CO2), of an air conditioning system for a vehicle.

In order to improve the interior and thermal comfort in a vehicle, an air conditioning system is generally used which is at least formed from a heating and refrigerant circuit, an air conditioning device and an air guidance system. In general, in specific driving states in which the vehicle engine or drive motor needs to produce a high power, for example when traveling up a steep slope or in the case of sharp acceleration, it may be necessary to limit the power output at a compressor of the refrigerant circuit. In order to ensure optimum functioning of the vehicle engine and of the transmission, the load torque of accessories, such as the refrigerant compressor, for example, is therefore detected and passed to an engine control device and/or a transmission control device. In general, when the load torque is limited in such a way depending on the driving situation, the refrigerant compressor is switched off by means of the engine control device or the transmission control device. Alternatively, it is known, for example from DE 101 06 243, to form the instantaneous load torque of the refrigerant compressor using a function of variables and to directly form a drive signal for the refrigerant compressor using a reciprocal function, which is associated with the function, depending on the predetermined maximum limit torque. In this case, the method for situation-dependent control of the refrigerant compressor, preferably for an R134a refrigerant compressor, is determined depending on the load torque predetermined by the engine control device.

The object of the invention is to specify a method and an apparatus for controlling a refrigerant circuit, in particular an R744 refrigerant circuit, which allows for interior air conditioning which is as effective as possible even when the load torque of a refrigerant compressor is limited on the basis of the driving situation.

According to the invention, the object is achieved by a method having the features of claim 1 and by an apparatus having the features of claim 12. Advantageous developments are the subject matters of the dependent claims.

In the method for controlling a refrigerant circuit of an air conditioning system for a vehicle, according to the invention a compressor arranged in the refrigerant circuit is controlled as a function of an evaporator temperature control and a load torque limitation function, which is integrated in the evaporator temperature control. Owing to such an integration or incorporation of a load torque limitation function in the normal process for controlling a refrigerant compressor, additional hardware components are reliably avoided. In particular, already existing sensors and actuators are used here. In addition, owing to the torque of the refrigerant compressor being limited depending on the driving situation instead of the refrigerant compressor being switched off or being driven in a manner which is merely dependent on the maximum limit torque, sufficiently effective air conditioning of the interior is still achieved even when there is a severe load on the vehicle engine. This makes improved operation of the vehicle engine and transmission possible. In addition, such a load torque limitation function of the refrigerant compressor can also result in a saving in terms of fuel (low idling speeds).

Expediently, a desired value for an evaporator temperature is predetermined in a basic control loop, in particular of superordinate control of an air conditioning control system, and this desired value is passed to an evaporator temperature controller for forming a manipulated variable, from which an actuating signal for a refrigerant compressor is derived. In the process, the manipulated variable is used to determine a desired high pressure value, which results in high pressure cascade control. In the control case, the evaporator temperature is in this case set via the high pressure control. In the limitation case, i.e. with the load torque limitation function to be taken into consideration, the evaporator temperature cannot be set as desired, with the result that the air conditioning system is operated at a reduced power. In the process, the deviation from the desired value for the evaporator temperature is reduced to a minimum. In addition, in the limitation case by means of the load torque limitation function, a continuous transition to the normal mode is brought about by, for example, the integral component of the evaporator temperature controller being kept constant. Even in the driving situations which are subject to a severe load, the power of the air conditioning system is therefore reduced as little as possible.

Preferably, the desired high pressure value is linked with the load torque limitation function via an MIN function. That is to say the two values present—the desired high pressure value and the initial value for the load torque limitation function—are compared with one another, the smaller value acting as the reference variable for the high pressure cascade control. In detail, the load torque limitation function is used to determine a present limit value for the desired high pressure value and passed to the MIN function. The desired high pressure value and the present limit value for the desired high pressure value are then used to determine, by means of the MIN function, the minimum value, which is passed to the high pressure control.

Expediently, the minimum value for the desired high pressure value is used to determine, by means of the high pressure controller, a manipulated variable for controlling the high pressure, the manipulated variable of the high pressure control being converted, using a transfer characteristic and a pulse-width modulator, into an actuating signal for controlling the displacement of the compressor.

The determination of the present limit value for the desired high pressure value from the maximum permissible load torque takes place using the load torque limitation function via a reciprocal function of the known functional dependence of the torque on high pressure, suction pressure, rotation speed and further parameters of an R744 refrigerant circuit. The reciprocal function can therefore also be referred to as the load torque limitation function. Given a high engine power and required limitation of the load torque of the refrigerant compressor, the drive signal is therefore derived from the above-described reciprocal function.

In order to determine the present limit value for the desired high pressure value using the reciprocal function with respect to the torque calculation function, at least one parameter, in particular a maximum permissible load torque, a present value for the suction pressure and/or for the rotation speed of the compressor, a degree of pulse width modulation for controlling the compressor control valve, a present value for the air mass flow via the evaporator, for the air inlet temperature, for the air temperature downstream of the evaporator and/or for the air inlet humidity is passed to the load torque limitation function. Even in the driving situations which are subjected to severe load, the air conditioning system is therefore operated at a reduced, but maximum possible power. In one further embodiment, when calculating the limit value, the present value for the suction pressure, for the air inlet temperature and for the air inlet humidity are not taken into consideration for simplified accuracy purposes.

As regards the apparatus for controlling the refrigerant circuit of the air conditioning system, the refrigerant compressor arranged in the refrigerant circuit can be controlled as a function of an evaporator temperature control and a load torque limitation function, which is integrated in the evaporator temperature control. In the process, a superordinate basic control loop for determining a desired value for an evaporator temperature and a downstream evaporator temperature controller are provided, which controller is used to determine a manipulated variable for the evaporator temperature control. In order to determine the desired high pressure value using the manipulated variable of the evaporator temperature controller, a basic characteristic, possibly with a correction characteristic, is preferably provided, a limitation module for limiting the desired high pressure value using the load torque limitation function being connected downstream of the basic characteristic. In this case, the load torque limitation function is connected in parallel with the evaporator temperature controller via the downstream limitation module, for example an MIN function.

The load torque limitation function is determined via various parameters, for example the suction pressure on the input side of the compressor, the compressor rotation speed, the evaporator temperature, and further input variables or parameters. For this purpose, the load torque limitation function is provided with a plurality of inputs. The limitation module is connected on the input side to an output of the load torque limitation function and to the desired high pressure value resulting from the control case. A high pressure controller is connected downstream of the limitation module. In order to drive the refrigerant compressor, a pulse-width modulator for forming a pulse width-modulated actuating signal for a control valve of the refrigerant compressor is connected downstream of the high pressure controller via a characteristic.

The advantages achieved by the invention consist in particular in the fact that, without additional components, required limitation of the refrigeration power and therefore also sufficiently effective interior air conditioning are ensured even in unfavorable conditions when there is a severe load on the engine side. Such a solution has advantages without additional physical space being required and without any additional requirements in terms of weight for the refrigerant circuit and a high degree of operational reliability owing to an automatic protective function based on the limitation function.

Exemplary embodiments of the invention will be explained in more detail with reference to a drawing. Therein, the figure shows an apparatus 1 for controlling a refrigerant circuit 2 of an air conditioning system 4 for a vehicle. The air conditioning system 4 may also be in the form of a combined device for cooling or heating air to be guided into an enclosed area, for example into the interior of a vehicle.

The air conditioning system 4 comprises a condenser 6 in the form of a gas cooler (referred to below as gas cooler 6) and an evaporator 8. The refrigerant circuit 2 represents a closed system, in which a refrigerant KM, for example carbon dioxide, R744, is guided from a compressor 10 to the gas cooler 6 and via an expansion valve 12 to the evaporator 8 in the circuit.

The refrigerant circuit 2 illustrated in the figure moreover comprises an internal heat exchanger 11. During operation of the refrigerant circuit 2, the refrigerant KM absorbs heat from air flowing into the vehicle and emits this heat again to the ambient air. For this purpose, it is necessary that the refrigerant KM has a sufficiently high temperature difference with respect to the air. In addition, cooling of the refrigerant KM takes place by means of pressure loss at the expansion valve 12 arranged in the refrigerant circuit 2; cooling of the air flowing into the vehicle interior takes place by heat being absorbed by the refrigerant KM in the evaporator 8.

In detail, the refrigerant circuit 2 comprises the compressor 10 having a variable displacement H for compressing the gaseous refrigerant KM, for example carbon dioxide. The compressor 10 takes in the gaseous refrigerant KM by suction. The sucked-in gaseous refrigerant KM has a low temperature and a low pressure. The refrigerant KM is compressed by the compressor 10. The gaseous and hot refrigerant KM is passed to the gas cooler 6. The refrigerant KM is cooled owing to the air flowing into the gas cooler 6.

The refrigerant KM cooled in the gas cooler 6 is passed to be subsequently fed, on the suction-pressure side, to the compressor 10 via the internal heat exchanger 11 and via the expansion valve 12, which acts as a throttle. In this case, expansion of the refrigerant KM results, such that the refrigerant KM is severely cooled. By means of the expansion valve 12, the cooled refrigerant KM is injected into the evaporator 8, where the refrigerant KM draws the required evaporation heat from the incoming air, for example fresh air. As a result, the air is cooled. The cooled air is passed via a fan (not illustrated in any more detail) and via air guides into the vehicle interior. After the compressor 8, the refrigerant KM is passed via the internal heat exchanger 11 on the suction-pressure side to the compressor 10 again.

In order to control the refrigerant circuit 4, owing to superordinate control (not illustrated here), a desired value SW(VT) for the evaporator temperature VT is predetermined, for example sliding from 2° C. to 10° C. By means of a temperature sensor 16, the actual value IW(VT) for the evaporator temperature VT is determined at the evaporator 8. The difference between the desired value SW(VT) and the actual value IW(VT) for the evaporator temperature VT is used to determine a control discrepancy RW(VT) for the evaporator temperature VT. The control discrepancy RW(VT) is passed to an evaporator temperature controller 18, for example a PI controller, which forms a manipulated variable U from this. A desired value SW(HD) for the high pressure HD of the refrigerant KM in the refrigerant circuit 2 downstream of the gas cooler 6 is derived from the manipulated variable U of the evaporator temperature controller 18 by means of a basic characteristic 20.

Owing to the material properties of the refrigerant KM, for example of R744, an additional correction characteristic KK is required, with which the desired value SW(HD) for the high pressure HD, which value is obtained from the basic characteristic 20, is modified in order to obtain a corrected or modified desired high pressure value kSW(HD). Examples of input variables E1 to En for correcting the desired value SW(HD) for the high pressure HD using the correction characteristic 20 are the air inlet temperature, the air inlet humidity, the quantity of air and/or the rotation speed of the compressor 10.

In order to achieve sufficiently effective interior air conditioning even when the vehicle is subjected to severe load on the engine side, provision is made for the power of the compressor 10 to be reduced or limited as little as possible, in which case shutdown of the compressor 10 should be avoided. For this purpose, a load torque limitation function 22 is provided which is connected in parallel with the evaporator temperature control VR and thus with the evaporator temperature controller 18.

In this case, the desired high pressure value SW(HD), in particular the corrected desired high pressure value kSW(HD), is limited, if required, using the load torque limitation function 22. In the control case, the evaporator temperature VT is set using the desired high pressure value SW(HD) or the corrected desired high pressure value kSW(HD). In the limitation case, i.e. in the case of the load torque limitation function 22 to be taken into consideration, the evaporator temperature VT cannot be set as desired, however, with the result that the air conditioning system is operated at a reduced power. For this purpose, the deviation from the desired value SW(VT) for the evaporator temperature VT is reduced to a minimum. For continuous transition between the control case and the limitation case, the integral component of the evaporator temperature controller 18 is kept constant or frozen during limitation. Even in the driving situations which are subject to severe loading, the air conditioning system is therefore operated at a reduced, but maximum possible power.

As shown in the figure, the desired high pressure value SW(HD) is linked with the load torque limitation function 22 via an MIN function of a limitation module 24 for limiting the power of the compressor 10. That is to say the two values present—the desired high pressure value SW(HD) and the initial value for the load torque limitation function 22, i.e. the limit value GW for the desired high pressure value SW(HD)—are compared with one another, the lower value acting as the reference variable in the form of the minimum value MW for the high pressure control HDR.

The instantaneous torque M of the compressor 10 is determined by means of a torque calculation function f using various parameters P, which are passed to the load torque limitation function 22. The following is true for the functional dependence of the instantaneous torque M of the compressor 10:
M=f(PRCA, PRCE, r_{c}, PWM, \dot{m}ₐᵢᵣ, T_{air inlet}, TLVA, φ_{air inlet}) [1]

where PRCA—refrigerant high pressure downstream of compressor, PRCE=refrigerant suction pressure upstream of compressor, r_{c}=compressor rotation speed, PWM=pulse width modulation for controlling the compressor control valve, \dot{m}ₐᵢᵣ=air mass flow via evaporator, T_{air inlet}=air inlet temperature, TLVA=air temperature downstream of compressor, φ_{pair inlet}=air inlet humidity (external or internal humidity).

In this case, the number of parameters P to be taken into consideration depends on the input in terms of the accuracy of the load torque calculation, with the result that parameters P, for example the refrigerant suction pressure PRCE upstream of the compressor, the air inlet temperature. T_{air inlet} or the air inlet humidity φ_{air inlet}, may also not be considered. Alternatively, the refrigerant suction pressure PRCE can also be determined via the air temperature TLVA downstream of the evaporator 8. In order to determine the load torque limitation, the family of characteristics of the torque calculation function f is converted into a reciprocal function f”, which predetermines a limit value GW for the high pressure HD (also referred to as high pressure limit value PRCAₗᵢₘ for short) as a function of a predetermined maximum permissible load torque Mₗᵢₘ (also referred to as torque limit value) as follows:
GW=f″(Mₗᵢₘ, PRCE, r_{c}, PWM, \dot{m}ₐᵢᵣ, T_{air inlet}, TLVA, φ_{pair inlet}) [2]

where Mₗᵢₘ=maximum permissible load torque.

The limit value GW, which is passed to the limitation module 24, and the desired high pressure value SW(HD) are then, in the control case, used to determine the resultant minimum value MW for the desired high pressure value SW(HD) and then passed to a high pressure controller 26.

Furthermore, in order to determine the actual high pressure value IW(HD), a pressure sensor 32 is provided which determines the high pressure HD in the refrigerant circuit 2 downstream or possibly upstream of the gas cooler 6. The difference between the minimum value MW for the desired high pressure value SW(HD) and the actual high pressure value IW(HD) is passed to the high pressure controller 26 as a pressure difference value Δp. The pressure difference value Δp is used to determine, by means of the high pressure controller 26, the manipulated variable S for controlling the displacement H of the compressor 10 using an associated control valve 30. The manipulated variable S is converted into a pulse width-modulated actuating signal SS for the control valve 30 by means of a pulse-width modulator 28 via an upstream transfer characteristic. Then, the pulse width-modulated actuating signal SS is passed to the control valve 30 of the compressor 10 for controlling the displacement H.

### LIST OF REFERENCE SYMBOLS

1 Apparatus for controlling a refrigerant circuit
2 Refrigerant circuit
4 Air conditioning system
6 Condenser (=gas cooler)
8 Evaporator
10 Compressor
11 Internal heat exchanger
12 Expansion valve
16 Temperature sensor
18 Evaporator temperature controller
20 Basic characteristic
22 Load torque limitation function
24 Limitation module
26 High pressure controller
28 Pulse-width modulator
30 Control valve
32 High pressure sensor
E1 to En Input variables
f Torque calculation function
f″ Reciprocal function with respect to the torque calculation function
GW Limit value for desired high pressure value
H Displacement of the compressor
HD High pressure
IW(HD) Actual high pressure value
IW(VT) Actual evaporator temperature value
KK Correction characteristic
KM Refrigerant
MW Minimum value for desired high pressure value
P Parameter
PRCE Refrigerant suction pressure
Δp Differential pressure value
RW(VT) Control discrepancy evaporator temperature
SS Actuating signal for control valve
S Manipulated variable of the high pressure controller
SW(HD) Desired high pressure value
kSW(HD) Modified desired high pressure value
SW(VT) Desired evaporator temperature value
TLVA Air temperature downstream of evaporator
U Manipulated variable of the evaporator temperature controller
VR Evaporator temperature control
VT Evaporator temperature

1. A method for controlling a refrigerant circuit of an air conditioning system for a vehicle, in which a compressor arranged in the refrigerant circuit is controlled as a function of an evaporator temperature control (VR) and a load torque limitation function, which is integrated in the evaporator temperature control (VR).

2. The method as claimed in claim 1, wherein a desired value (SW(VT)) for an evaporator temperature (VT) is predetermined in a basic control loop, and this desired value is passed to an evaporator temperature controller for forming a manipulated variable (U) for the evaporator temperature (VT).

3. The method as claimed in claim 2, wherein the manipulated variable (U) for the evaporator temperature (VT) is used to determine a desired high pressure value (SW(HD)), which is limited, at least in regions, using the load torque limitation function.

4. The method as claimed in claim 3, wherein the desired high pressure value (SW(HD)) is linked with the load torque limitation function via an MIN function.

5. The method as claimed in claim 4, wherein the MIN function is used to determine a resultant minimum value (MW) for the desired high pressure value (SW(HD)).

6. The method as claimed in claim 4, wherein the load torque limitation function is used to determine a present limit value (GW) for the desired high pressure value (SW(HD)), in which case the present limit value (GW) is linked with the desired high pressure value (SW(HD)) via the MIN function.

7. The method as claimed in claim 6, wherein the desired high pressure value (SW(HD)) and the present limit value (GW) for the desired high pressure value (SW(HD)) are used to determine, by means of the MIN function, a minimum value (MW), which is passed to a high pressure controller.

8. The method as claimed in claim 7, wherein the minimum value (MW) for the desired high pressure value (SW(HD)) is used to determine, by means of the high pressure controller, a manipulated variable (S) for the high pressure control (HDR).

9. The method as claimed in claim 8, wherein the manipulated variable (S) of the high pressure control (HDR) is converted, using a transfer characteristic and a pulse-width modulator, into an actuating signal (SS) for controlling the displacement (H) of the compressor.

10. The method as claimed in claim 6, wherein at least one parameter (P), in particular a maximum permissible load torque (Mₗᵢₘ), a present value for the suction pressure (PRCE) and/or for the rotation speed (r_{c}) of the compressor, a degree of pulse width modulation (PWM) for controlling the compressor control valve, a present value for the air mass flow (mₐᵢᵣ) via the evaporator, for the air inlet temperature (T_{air inlet}), for the air temperature (TLVA) downstream of the evaporator and/or for the air inlet humidity (φ_{air inlet}) is passed to the load torque limitation function for determining the present limit value (GW) for the desired high pressure value (SW(HD)) using a reciprocal function (f′) with respect to the torque calculation function (f).

11. The method as claimed in claim 10, wherein the load torque limitation function uses the reciprocal function (f′), without taking into consideration the present value for the suction pressure (PRCE), the present value for the air inlet temperature (T_{air inlet}) and the present value for the air inlet humidity (φ_{air inlet}), to determine the present limit value (GW) for the desired high pressure value (SW(HD)) with sufficiently coarse accuracy.

12. An apparatus for controlling a refrigerant circuit of an air conditioning system for a vehicle, wherein a compressor arranged in the refrigerant circuit can be controlled as a function of an evaporator temperature control (VR) and a load torque limitation function, which is integrated in the evaporator temperature control (VR).

13. The apparatus as claimed in claim 12, wherein a basic control loop for determining a desired value (SW(VT)) for an evaporator temperature (VT) and a downstream evaporator temperature controller are provided, which controller is used to determine a manipulated variable (U) for the evaporator temperature control (VR).

14. The apparatus as claimed in claim 13, wherein a basic characteristic for determining a desired high pressure value (SW(HD)) using the manipulated variable (U) for the evaporator temperature (VT) is provided, and a limitation module for limiting the desired high pressure value (SW(HD)) using the load torque limitation function is connected downstream of the basic characteristic.

15. The apparatus as claimed in claim 14, wherein the limitation module comprises an MIN function.

16. The apparatus as claimed in claim 12, wherein the load torque limitation function is provided with a plurality of inputs.

17. The apparatus as claimed in claim 13, wherein the load torque limitation function is connected in parallel with the evaporator temperature controller.

18. The apparatus as claimed in claim 13, wherein the limitation module is connected on the input side to an output of the load torque limitation function.

19. The apparatus as claimed in claim 12, wherein the load torque limitation function for determining the limit value (GW) represents a reciprocal function (f′) with respect to the torque calculation function (f), where M=f(PRCA, PRCE, r_{c}, PWM, mₐᵢᵣ, T_{air inlet}, TLVA and/or (φ_{air inlet}).

20. The apparatus as claimed in claim 13, wherein a high pressure controller is connected downstream of the limitation module.

21. The apparatus as claimed in claim 20, wherein a pulse-width modulator for forming a pulse width-modulated actuating signal (SS) for a control valve of a compressor is connected downstream of the high pressure controller.
